(19) United States
(12) Patent Application Publication
(10) Pub. No.: US 2008/0143762 A1
(43) Pub. Date: Jun. 19, 2008

(54) Symbol having encoded information

(76) Inventor: Andrei Obrea, Seymour, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/642,009

(22) Filed: Dec. 19, 2006

(51) Int. Cl. B41J 29/38; G06K 7/01; G06K 19/06

(52) U.S. Cl. 347/6; 235/435; 235/494

(57) ABSTRACT

A method of printing including determining a symbol to be printed; segmenting the symbol to be printed into a plurality of symbol sections; and for each of the symbol sections, selecting an ink to be used to print the symbol section from a group of at least two different inks, wherein encoded information is provided in the symbol when the symbol is printed based upon location of at least one of the different inks in the symbol.

### FIELD OF THE INVENTION

The invention relates to printing an indicium, symbol or marking and, more particularly, to an indicium, symbol or marking having additional encoded information.

### BRIEF DESCRIPTION OF PRIOR DEVELOPMENTS

U.S. Pat. No. 5,153,418 discloses multiple resolution machine readable symbols. U.S. Patent Application Publication No. 2005/0269416 A1, which is hereby incorporated by reference in its entirety, discloses providing additional information in a printed symbol. Printing of indicium with a color luminescent ink, such as a fluorescent ink or a phosphorescent ink, is described in U.S. patent application Ser. No. 10/692,569 filed Oct. 24, 2003, which is hereby incorporated by reference in its entirety. Dark color fluorescent inks (e.g., dual luminescent) are described in U.S. patent application publication Nos. US 2002/0195586 A1, US 2003/0005303 A1, and US 2003/0041774 A1, which are hereby incorporated by reference in their entireties.

There is a desire to provide an indicium, symbol or marking which contains at least two different types of information, such as second information which is encoded when first information, such as an alphanumeric character for example, is formed. This increased density information storage can be used for any suitable purpose, such as in the postal environment for example.

### SUMMARY OF THE INVENTION

In accordance with one aspect of the invention, a method of printing is provided including determining a symbol to be printed; segmenting the symbol to be printed into a plurality of symbol sections; and for each of the symbol sections, selecting an ink to be used to print the symbol section from a group of at least two different inks, wherein encoded information is provided in the symbol when the symbol is printed based upon location of at least one of the different inks in the symbol.

In accordance with another aspect of the invention, a method of printing is provided comprising determining an area for printing a symbol; determining different segments of the area to print different sections of the symbol; and printing the sections of the symbol with at least two different inks. A first one of the sections of the symbol in a first one of the segments of the area is printed with a first one of the inks. A second one of the sections of the symbol in a second one of the segments of the area is printed with a second one of the inks. Information is encoded into the symbol during printing of the symbol sections based upon location of at least one of the inks relative to the area segments.

In accordance with another aspect of the invention, a printer is provided comprising a supply of ink comprising at least two different inks; means for printing the inks to form a symbol, wherein the means for printing is adapted to print at least two different sections of the symbol with respective ones of the different inks; and means for encoding information in the symbol during printing of the symbol. The means for encoding is adapted to encode the information by selecting at least one location for using a first one of the inks to print at least one of the sections of the symbol.

In accordance with another aspect of the invention, a printer is provided comprising a supply of ink comprising at least two different inks; and a controller for controlling printing of the inks to form a multi-ink symbol. The controller is adapted to determine different sections of the symbol to be printed with respective ones of the different inks to thereby provide encoded information in the symbol based upon location of the sections printed with at least one of the inks relative to predetermined symbol location segments of an area where the symbol is intended to be printed.

In accordance with another aspect of the invention, a method for reading information is provided comprising determining an area having a symbol; dividing the area into a plurality of segments, wherein different sections of the symbol are located in different ones of the segments of the area; and determining encoded information stored in the symbol based upon location at least one predetermined ink, used to form the symbol, in at least one of the segments of the area.

In accordance with another aspect of the invention, a reader for reading information is provided comprising means for scanning a symbol wherein the symbol is printed with at least two sections of the symbol comprising at least two respective different inks; means for dividing an area, which the symbol occupies, into area segments; means for determining location of at least one of the sections of the symbol, printed with a first one of the inks, relative to the area segments; and means for decoding information stored in the symbol based, at least partially, upon location of the first ink relative to the area segments.

In accordance with another aspect of the invention, an alphanumeric symbol is provided comprising at least two different sections of the symbol being formed with different respective inks. The symbol occupies an area with the sections located in different segments of the area. Encoded information is provided in the alphanumeric symbol based upon location of at least one of the inks in at least one segments of the area.

### BRIEF DESCRIPTION OF THE DRAWINGS

The foregoing aspects and other features of the invention are explained in the following description, taken in connection with the accompanying drawings, wherein:

FIG. 1 is a plan view of a mail piece comprising a marking incorporating features of the invention;

FIG. 2 is a block diagram of an example of a printer used to print the marking shown in FIG. 1;

FIG. 3 is a diagram showing a printed character having features of the invention;

FIG. 4 is a diagram as in FIG. 3 printed with different encoded information;

FIG. 5 is a diagram as in FIGS. 3 and 4 printed with different encoded information;

FIG. 6 is a diagram showing a printed character having features of the invention with the same encoded information as the embodiment shown in FIG. 3; and

FIG. 7 is a block diagram showing one example of a device used to read and further process a mail piece having a marking incorporating features of the invention.

### DETAILED DESCRIPTION OF THE PREFERRED EMBODIMENTS

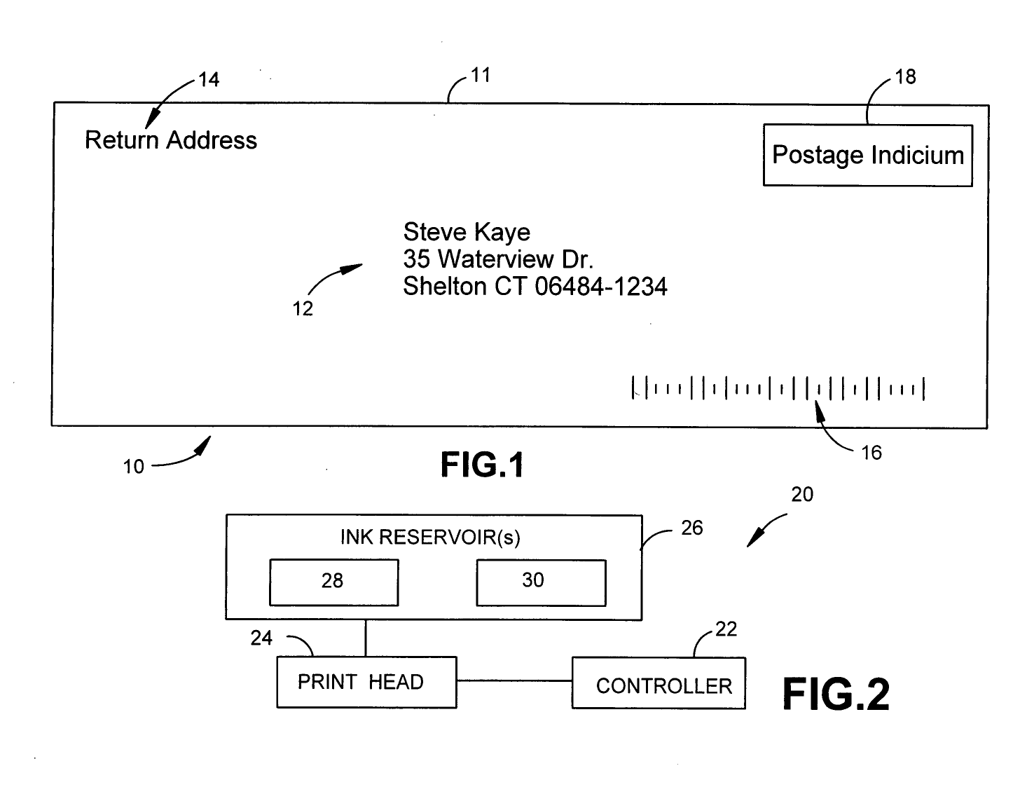

Referring to FIG. 1, there is shown a plan view of a mail piece 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used. Features of the invention do not need to be used on a mail piece, and could be used in other types of articles or documents. A mail piece is only an exemplary embodiment.

The mail piece 10 shown in FIG. 1 comprises an envelope. However, in alternate embodiments, the mail piece could comprise any suitable type of mail piece including a package for example. The mail piece 10 includes the envelope or substrate 11, and three mail piece markings 12, 14, 16. However, features of the invention could be used on a mail piece with more or less than three mail piece markings. The marking(s) can include any suitable type of markings including a printed marking comprising characters and/or symbols for example. Postage indicium 18 can be applied to the envelope after the mail piece markings are applied. The postage indicium 18 could be printed directly on the substrate 11, printed on a label which is subsequently attached to the substrate, or could comprise a postage stamp, for example. In the embodiment shown, the mail piece marking comprises a destination address 12, a return address 14, and a Planet bar code 16. The mail piece marking could include an address block Postnet bar code for example.

Referring also to FIG. 2, a schematic diagram of a printing device 20 for printing any one or more of the mail piece markings 12-16 and/or postage indicium 18 on the envelope 11 is shown. The printing device could comprise any suitable type of device for printing mail piece markings or indicium on a mail piece substrate, including a mailing label for example. For example, the printing device could comprise a desktop computer with a computer printer, or a dedicated mailing/addressing machine printer. The printing device 20 generally comprises at least one print head 24, a controller 22, and at least one ink reservoir 26. The ink reservoir 26 preferably comprises at least two different inks 28, 30. The controller 22 is adapted to control printing of the inks from the ink reservoir 26 by the print head 24 on the mail piece substrate. The controller 22 preferably comprises a processor and suitable software programming.

The first ink 28 preferably comprises a normal printer ink, such as a non-luminescent black ink for example. The second ink preferably comprises a color luminescent ink, such as a fluorescent ink or a phosphorescent ink, such as described in U.S. patent application Ser. No. 10/692,569 filed Oct. 24, 2003, U.S. Pat. No. 6,827,769, and U.S. Pat. No. 6,793,723 which are hereby incorporated by reference in their entireties. In a preferred embodiment, the first and second inks have a substantially same color in normal daylight when viewed by a person, such as black for example. Because the second ink is a luminescent ink, it can be excited by a radiation source, such as an Ultraviolet (UV) light, to read the ink separate from other ink(s). U.S. patent application Ser. No. 11/311,742 filed Dec. 19, 2005, which is hereby incorporated by reference in its entirety, also discloses mail markings with key encoding.

In one type of alternate embodiment, features of the invention could be used with both of the inks 28, 30 comprising luminescent inks (fluorescent or phosphorescent for example), such as with different colors or different luminescent qualities. In another type of alternate embodiment both inks 28, 30 could comprise non-luminescent inks, just having different colors. In another type of alternate embodiment, one or both inks 28, 30 could comprise identification fluorescent nanoparticle quantum dots or rare earth-doped nanoparticles such as described in U.S. patent application Ser. No. 11/290,728, filed Nov. 30, 2005 which is hereby incorporated by reference in its entirety. Any suitable type of metameric inks could be used with the invention.

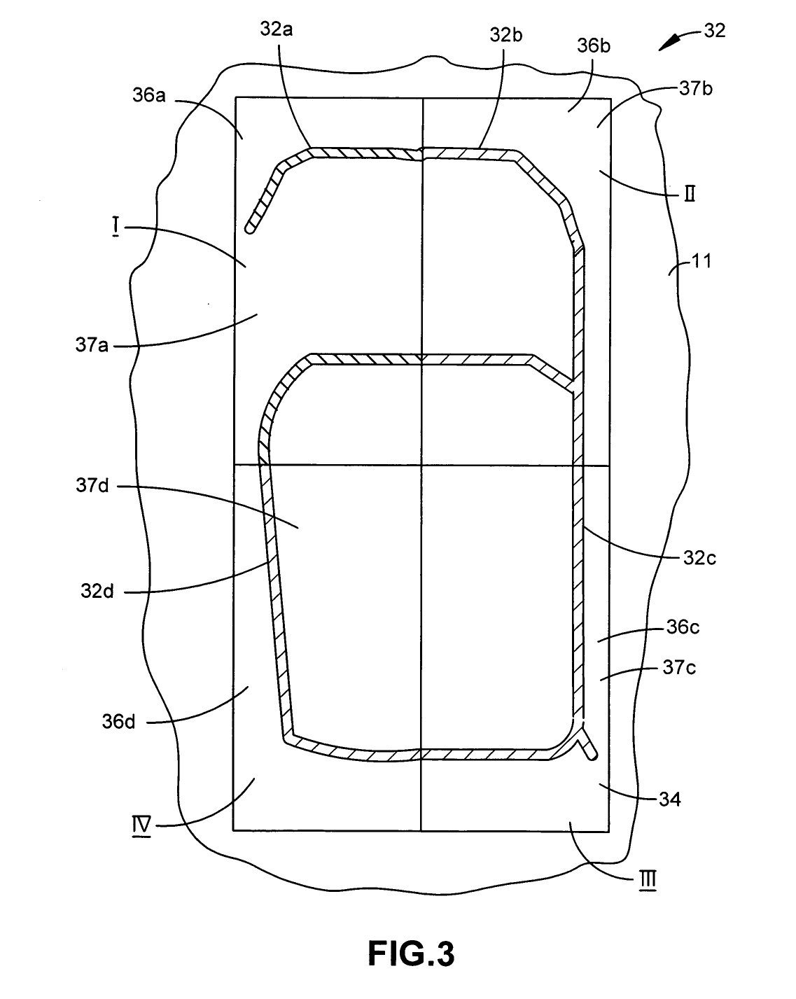

Referring now also to FIG. 3, a symbol 32, in this example a human readable alphanumeric character of mail piece marking 12 is shown. As noted above, the invention could alternatively or additionally be used in the mail piece markings 14 or 16, or in the postage indicium 18, or any other suitable type of mail piece marking including a picture or other symbol for example. The symbol 32 in this example is the letter “a”. The symbol 32 is printed on an area 34 of the substrate 11. The area 34 is determined by the controller 20 when the controller is to print the symbol 32. The controller 22 is adapted to divide the area 34 into segments 36. In this example, the controller has divided the area into four segments 36a, 36b, 36c, 36d of generally equal size and shape; quadrants I, II, III, and IV. However, in alternate embodiments more or less than four segments could be provided, and the segments might not be equal in size and/or shape.

The controller 22 is adapted to print sections 32a, 32b, 32c and 32d of the symbol 32 in respective ones of the segments 36a, 36b, 36c, and 36d of the area 34. More specifically, the controller 22 is adapted to control the print head 24 to print each section 32a-32d with one of the inks 28, 30. In the example shown, the first section 32a is printed with the first ink 28 and the second through fourth sections 32b-32d are printed with the second ink 30. For example, the first ink 28 could be a red ink such that the first section 32a of the symbol 32 is black non-fluorescent, and the second ink 30 could be black fluorescent ink such that the second through fourth sections 32b-32d of the symbol are fluorescent when exposed to an excitation source. The segments 36 only comprise sections of the symbol 32 printed in one of the inks 28 or 30. However, in alternate embodiments, one or more of the segments 36 could comprise more than one symbol section printed with more than one ink.

Selection of which ink to use for each section and in each segment is preferably controlled by an algorithm in the controller 22, and can include a look-up table for example. The invention can provide a method to further increase the information density encoded into the symbol 32 with metameric inks. An algorithm, known both to the printing subsystem and the reading subsystem, divides the area covered by a symbol (mark) 32 in any number of sections.

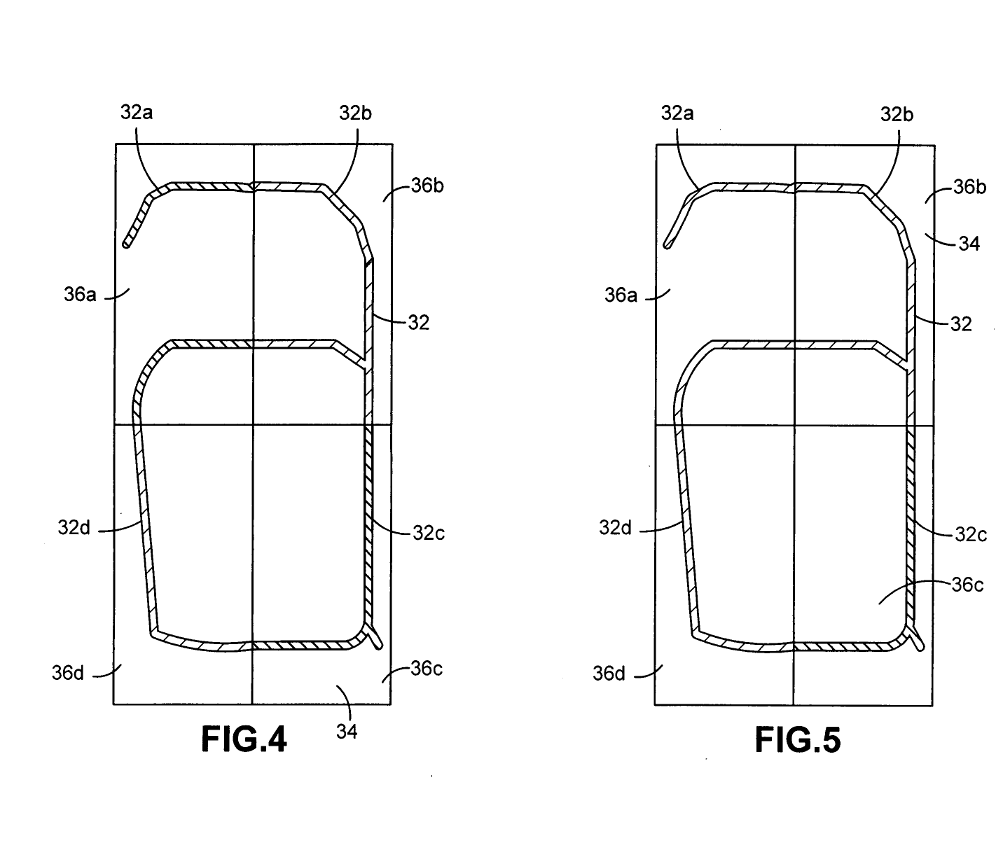

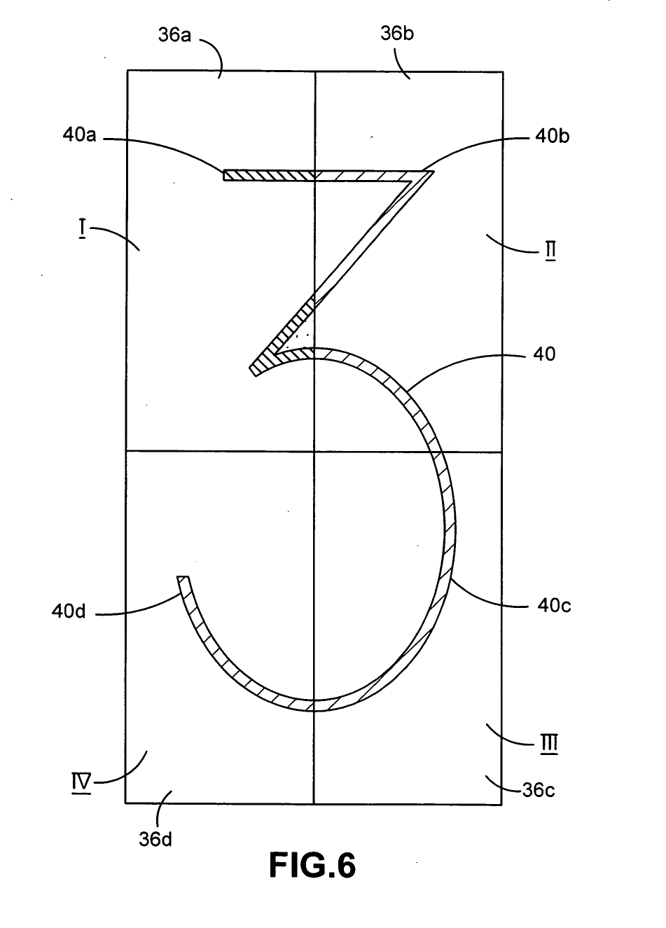

Using the table shown below, which corresponds to the four quadrant segmenting shown in FIG. 3, one can encode the sixteen available combinations to represent a number from 0 to 15. In this example table, the letter “a” shown in the mail piece marking 12 in FIG. 1 and shown in an enlarged view in FIG. 3 encodes the number 7.

| | En- | | | | |
|---|---|---|---|---|---|
| | coded | | | | |
| | Infor- | Quadrant/Ink | | | |
| FIG. | mation | I | II | III | IV |
| | 0 | First Ink 28 | First Ink | First Ink 28 | First Ink 28 |
| | | | 28 | | |
| | 1 | First Ink 28 | First Ink | First Ink 28 | Second Ink |
| | | | 28 | | 30 |
| | 2 | First Ink 28 | First Ink | Second Ink | First Ink 28 |
| | | | 28 | 30 | |
| | 3 | First Ink 28 | First Ink | Second Ink | Second Ink |
| | | | 28 | 30 | 30 |
| | 4 | First Ink 28 | Second | First Ink 28 | First Ink 28 |
| | | | Ink 30 | | |
| FIG. 4 | 5 | First Ink 28 | Second | First Ink 28 | Second Ink |
| | | | Ink 30 | | 30 |
| | 6 | First Ink 28 | Second | Second Ink | First Ink 28 |
| | | | Ink 30 | 30 | |
| FIG. 3 | 7 | First Ink 28 | Second | Second Ink | Second Ink |
| and | | | Ink 30 | 30 | 30 |
| FIG. 6 | | | | | |
| | 8 | Second Ink | First Ink | First Ink 28 | First Ink 28 |
| | | 30 | 28 | | |
| | 9 | Second Ink | First Ink | First Ink 28 | Second Ink |
| | | 30 | 28 | | 30 |
| | 10 | Second Ink | First Ink | Second Ink | First Ink 28 |
| | | 30 | 28 | 30 | |
| | 11 | Second Ink | First Ink | Second Ink | Second Ink |
| | | 30 | 28 | 30 | 30 |
| | 12 | Second Ink | Second | First Ink 28 | First Ink 28 |
| | | 30 | Ink 30 | | |
| FIG. 5 | 13 | Second Ink | Second | First Ink 28 | Second Ink |
| | | 30 | Ink 30 | | 30 |
| | 14 | Second Ink | Second | Second Ink | First Ink 28 |
| | | 30 | Ink 30 | 30 | |
| | 15 | Second Ink | Second | Second Ink | Second Ink |
| | | 30 | Ink 30 | 30 | 30 |

The codes above can be further interpreted as binary information and used in any number of applications. Note that the backgrounds 37a-37d may also be used to encode information in a similar way.

FIGS. 4 and 5 shown two other examples where the same symbol 32 is printed in the same area 34, but the sections 32a-32d are printed with different ones of the inks 28, 30 in different ones of the segments 36a-36d. The letter “a” shown in FIG. 4 encodes the number 5 and the letter “a” shown in FIG. 5 encodes the number 13. In the embodiment shown in FIG. 3, the symbol 32 contains first information; the letter “a”. In FIG. 3 the symbol 32 also includes second information provided in an encoded form due to different inks being used in the area segments 36a-36d; the number “7”. In the embodiment shown in FIG. 4, the symbol 32 contains first information; the letter “a”. In FIG. 4 the symbol 32 also includes second information provided in an encoded form due to different inks being used in the area segments 36a-36d; the number “5”. In the embodiment shown in FIG. 5, the symbol 32 contains first information; the letter “a”. In FIG. 5 the symbol 32 also includes second information provided in an encoded form due to different inks being used in the area segments 36a-36d; the number “13”.

FIG. 6 shows another example where the symbol 40 is the number “3” and the segments 36a-36d have the same ink pattern as in FIG. 3 to encode the number “7” by the ink used in the sections 40a-40d of the symbol 40. In the embodiment shown in FIG. 6, the symbol 40 contains first information; the number “3”. The symbol 40 also includes second information provided in an encoded form due to different inks being used in the area segments 40a-40d; the number “7”. Thus, even though the examples in FIGS. 3 and 6 have different symbols 32 and 40 (different first information), they both have the same encoded second information; “7”. Likewise, even though the symbols 32 in FIGS. 3-5 have the same first information “a”, they have different second encoded information “7”, “13” and “5” respectively. In an alternate embodiment, the first information might not be a human readable mark, such as part of a bar code for example.

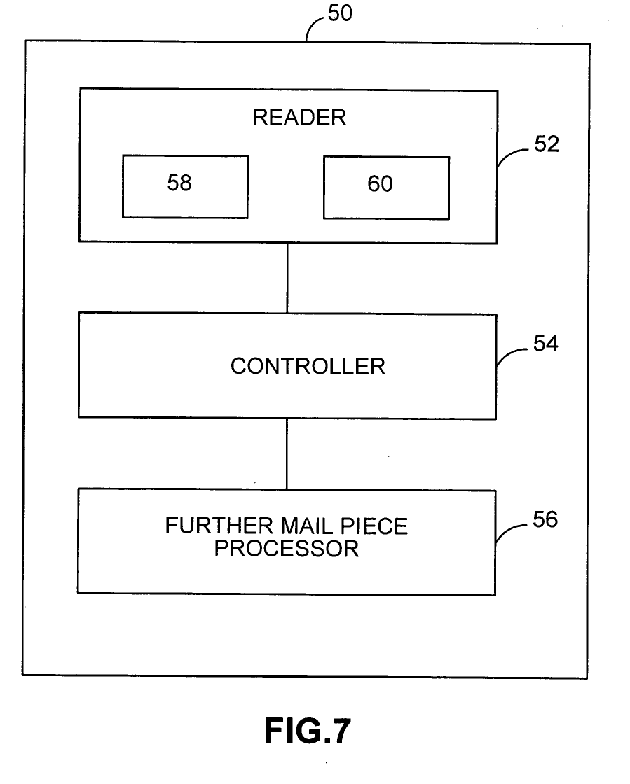

For the mail piece example shown in FIG. 1, after the mail piece markings are printed or applied to the mail piece substrate or label, the mail piece can be further processed. Referring also to FIG. 7, a device 50 is shown which is adapted to further process the mail piece. The device 50 could be at least a part of the device 20 shown in FIG. 2. However, in this embodiment, the device 50 is a separate device from the device 20. The device 50 generally comprises a reader 52, a controller 54, and at least one further mail piece processor 56. The device 50 could comprise additional features.

The reader 52 generally comprises an excitation source 58 and a scanner 60. The mail piece can be passed by the excitation source 58 and exposed to an energy source, such as UV light for example, to excite the second ink 30 printed in the sections of the symbol. The scanner 60 is adapted to read the image produced by the luminescent second ink 30. A corresponding signal is sent from the reader 52 to the controller 54 based upon which of the segments 36 contain the second ink 30. The controller is adapted to send a signal to the further processor 56 based upon the signal received from the reader 52 and programming or a data base of the controller. For example, if one of the area segments 36a or 36b or 36c or 36d has the ink 30 in it, a signal “1” could be sent for that area segment. If the segment does not have the ink 30, the signal “0” (zero) could be sent or no signal is sent for that area segment. For the example shown in FIG. 3, the signal could be a digital signal “0111” for the encoded information corresponding to the segments 36a=0, 36b=1, 36c=1, 36d=1 based upon the type of inks being used in the segments 36a-36d (regardless of what the first information actually is).

The further processor can include, for example, a postage meter which can print the postage indicium 18 on the mail piece 10 or a label to be applied to the mail piece. The value of the postage indicium 18 could be at least partially selected based upon the information of the second information in at least one of the second sections 34 of the mail piece marking 12. For example, if the second information contains postage class information, the postage indicium 18 would be selected based upon the postage class information contained in the second section 34. Alternatively or additionally, the encoded information could be used, at least partially, for confirmation or verification of the symbol or the postage indicium 18. For example, the symbol could be the number “6” and the encoded information could comprise the number “6”.

The further processing could comprise additional or alternate further processing of the mail piece. For example, if the second information contained a value added service, such as email tracking notification or certified mail for example, the further processor 56 could print additional information on the mail piece substrate or attach a label or tag to the mail piece substrate 11. These are only some examples, any suitable further automatic processing based upon the second information stored in the mail piece markings could be provided. The mail piece could have multiple mail piece markings with stored second information as well as their first information.

With the invention, a method of printing can be provided comprising determining a symbol to be printed; segmenting the symbol to be printed into a plurality of symbol sections; and for each of the symbol sections, selecting an ink to be used to print the symbol section from a group of at least two different inks, wherein encoded information is provided in the symbol when the symbol is printed based upon location of at least one of the different inks in the symbol. The symbol can comprise a single alphanumeric character, an area or element of a barcode, or an image such as a picture for example. Segmenting the symbol can comprise determining an area on which the symbol is intended to be printed, and dividing the area into encoding segments, wherein the symbol sections are located in separate respective ones of the encoding segments. The segments can be generally equally sized, but not necessarily. Selecting an ink can comprise selecting a luminescent ink as at least one of the inks used to print at least one of the symbol sections. Selecting an ink can comprise selecting a first ink for printing a first one of the symbol sections and a second different ink for printing a second one of the symbol sections, wherein the first and second inks have different colors. Selecting an ink can comprise selecting a first luminescent ink for printing a first one of the symbol sections and a second different luminescent ink for printing a second one of the symbol sections, wherein the first and second inks have different luminescent properties.

With the invention, a method of printing can be provided comprising determining an area for printing a symbol; determining different segments of the area to print different sections of the symbol; and printing the sections of the symbol with at least two different inks. A first one of the sections of the symbol in a first one of the segments of the area can be printed with a first one of the inks and a second one of the sections of the symbol in a second one of the segments of the area can be printed with a second one of the inks. Information can be encoded into the symbol during printing of the symbol sections based upon location of at least one of the inks relative to the area segments. The symbol can comprise a single alphanumeric character, and determining different segments of the area to print different sections of the symbol can comprise determining different segments of the area to print different sections of the single alphanumeric character. Determining different segments of the area can comprise dividing the area into equal sized and shaped segments.

With the invention, a printer can be provided comprising a supply of ink comprising at least two different inks; means for printing the inks to form a symbol, wherein the means for printing is adapted to print at least two different sections of the symbol with respective ones of the different inks; and means for encoding information in the symbol during printing of the symbol. The means for encoding can be adapted to encode the information by selecting at least one location for using a first one of the inks to print at least one of the sections of the symbol.

With the invention, a printer can be provided comprising a supply of ink comprising at least two different inks; and a controller for controlling printing of the inks to form a multi-ink symbol. The controller can be adapted to determine different sections of the symbol to be printed with respective ones of the different inks to thereby provide encoded information in the symbol based upon location of the sections printed with at least one of the inks relative to predetermined symbol location segments of an area where the symbol is intended to be printed.

With the invention, a method for reading information can be provided comprising determining an area having a symbol; dividing the area into a plurality of segments, wherein different sections of the symbol are located in different ones of the segments of the area; and determining encoded information stored in the symbol based upon location at least one predetermined ink, used to form the symbol, in at least one of the segments of the area.

With the invention, a reader for reading information can be provided comprising means for scanning a symbol wherein the symbol is printed with at least two sections of the symbol comprising at least two respective different inks; means for dividing an area, which the symbol occupies, into area segments; means for determining location of at least one of the sections of the symbol, printed with a first one of the inks, relative to the area segments; and means for decoding information stored in the symbol based, at least partially, upon location of the first ink relative to the area segments.

With the invention, an alphanumeric symbol can be provided comprising at least two different sections of the symbol being formed with different respective inks, wherein the symbol occupies an area with the sections located in different segments of the area, and wherein encoded information is provided in the alphanumeric symbol based upon location of at least one of the inks in at least one segments of the area.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A method of printing comprising:
determining a symbol to be printed;
segmenting the symbol to be printed into a plurality of symbol sections; and
for each of the symbol sections, selecting an ink to be used to print the symbol section from a group of at least two different inks, wherein encoded information is provided in the symbol when the symbol is printed based upon location of at least one of the different inks in the symbol.

2. A method of printing as in claim 1 wherein the symbol comprises a single alphanumeric character.

3. A method of printing as in claim 1 wherein segmenting the symbol comprises determining an area on which the symbol is intended to be printed, and further comprises dividing the area into encoding segments, wherein the symbol sections are located in separate respective ones of the encoding segments.

4. A method of printing as in claim 3 wherein the segments are generally equally sized.

5. A method of printing as in claim 1 wherein selecting an ink comprises selecting a luminescent ink as at least one of the inks used to print at least one of the symbol sections.

6. A method of printing as in claim 1 wherein selecting an ink comprises selecting a first ink for printing a first one of the symbol sections and a second different ink for printing a second one of the symbol sections, and wherein the first and second inks have different colors.

7. A method of printing as in claim 1 wherein selecting an ink comprises selecting a first luminescent ink for printing a first one of the symbol sections and a second different luminescent ink for printing a second one of the symbol sections, and wherein the first and second inks have different metameric, color or luminescent properties.

8. A method of printing as in claim 1 further comprising:
determining an area for printing the symbol;
determining different segments of the area to print respective ones of the sections of the symbol; and
printing the sections of the symbol with the different inks, wherein a first one of the sections of the symbol in a first one of the segments of the area is printed with a first one of the inks and a second one of the sections of the symbol in a second one of the segments of the area is printed with a second one of the inks, and wherein the information is encoded into the symbol based upon location of at least one of the inks relative to the area segments.

9. A method of printing comprising:
determining an area for printing a symbol;
determining different segments of the area to print different sections of the symbol; and
printing the sections of the symbol with at least two different inks, wherein a first one of the sections of the symbol in a first one of the segments of the area is printed with a first one of the inks and a second one of the sections of the symbol in a second one of the segments of the area is printed with a second one of the inks, and wherein information is encoded into the symbol during printing of the symbol sections based upon location of at least one of the inks relative to the area segments.

10. A method of printing as in claim 9 wherein the symbol comprises a single alphanumeric character, and determining different segments of the area to print different sections of the symbol comprises determining different segments of the area to print different sections of the single alphanumeric character.

11. A method of printing as in claim 9 wherein determining different segments of the area comprises dividing the area into equal sized and shaped segments.

12. A method of printing as in claim 11 wherein the segments comprise quadrants of the area.

13. A method of printing as in claim 9 wherein printing the symbol comprises printing a first one of the sections with a luminescent ink and printing a second one of the sections with a non-luminescent ink.

14. A method of printing as in claim 9 wherein printing the symbol comprises printing a first one of the sections with an ink having a first color and printing a second one of the sections with an ink having a second different color.

15. A method of printing as in claim 9 wherein printing the symbol comprises printing a first one of the sections with a first luminescent ink and printing a second one of the sections with a second different luminescent ink, and wherein the first and second inks have different luminescent properties.

16. A printer comprising:
a supply of ink comprising at least two different inks;
means for printing the inks to form a symbol, wherein the means for printing is adapted to print at least two different sections of the symbol with respective ones of the different inks; and
means for encoding information in the symbol during printing of the symbol, wherein the means for encoding is adapted to encode the information by selecting at least one location for using a first one of the inks to print at least one of the sections of the symbol.

17. A printer comprising:
a supply of ink comprising at least two different inks; and
a controller for controlling printing of the inks to form a multi-ink symbol, wherein the controller is adapted to determine different sections of the symbol to be printed with respective ones of the different inks to thereby provide encoded information in the symbol based upon location of the sections printed with at least one of the inks relative to predetermined symbol location segments of an area where the symbol is intended to be printed.

18. A method for reading information comprising:
determining an area having a symbol;
dividing the area into a plurality of segments, wherein different sections of the symbol are located in different ones of the segments of the area; and
determining encoded information stored in the symbol based upon location at least one predetermined ink, used to form the symbol, in at least one of the segments of the area.

19. A reader for reading information comprising:
means for scanning a symbol wherein the symbol is printed with at least two sections of the symbol comprising at least two respective different inks;
means for dividing an area, which the symbol occupies, into area segments;
means for determining location of at least one of the sections of the symbol, printed with a first one of the inks, relative to the area segments; and
means for decoding information stored in the symbol based, at least partially, upon location of the first ink relative to the area segments.

20. A human readable alphanumeric symbol comprising at least two different sections of the symbol being formed with different respective inks, wherein the symbol occupies an area with the sections located in different segments of the area, and wherein encoded information is provided in the alphanumeric symbol based upon location of at least one of the inks in at least one segments of the area.
